(19) United States
(12) Patent Application Publication
(10) Pub. No.: US 2009/0054141 A1
(43) Pub. Date: Feb. 26, 2009

(54) SYSTEM AND METHOD FOR EMBEDDING GRAPHICS FROM A GRAPHICAL APPLICATION IN A BROWSER

(76) Inventors: Joshua D. Williams, Eugene, OR (US); Timothy R. Gift, Eugene, OR (US); Mark D. Frohnmayer, Eugene, OR (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/197,851

(22) Filed: Aug. 25, 2008

Related U.S. Application Data
(63) Continuation of application No. PCT/US08/73660, filed on Aug. 20, 2008.
(60) Provisional application No. 60/956,891, filed on Aug. 20, 2007.

(51) Int. Cl. G06F 17/00

(52) U.S. Cl. 463/31; 463/42

(57) ABSTRACT

The invention provides a client computer system, including at least one storage medium, at least one processor connected to the storage medium, and a set of instructions stored on the storage medium for execution by the processor, the set of instructions including a communications module to receive and transmit signals to remote computer systems over a network, a browser residing on the storage medium, the browser having a window for displaying components in the signals, a graphical application residing on the storage medium, the graphical application utilizing the signals to render graphics, and a plug-in residing on the storage medium, the plug-in being embedding the graphics rendered by the graphical application in the window of the browser.

### CROSS-REFERENCE TO RELATED APPLICATIONS

This application is a Continuation of International Application No.: PCT/US08/73660 filed Aug. 20, 2008 which claims priority from U.S. Provisional Patent Application No. 60/956,891 filed on Aug. 20, 2007, which is incorporated herein by reference in its entirety.

### BACKGROUND OF THE INVENTION

1). Field of the Invention

Aspects of the present invention relate generally to a network system, and more specifically to a plug-in for a browser and to multiplayer games.

2). Discussion of Related Art

The internet is often used for playing multiplayer games between players at remote player computer systems. A shared game environment is often stored on a game server computer system and is downloadable for viewing at the respective remote player computer systems. Game components such as characters, chess and other board game pieces, cards, etc. are associated with the remote player computer systems. Player scores are stored at the game server computer system and are viewable at the respective remote player computer systems. The scores are updated when certain game thresholds are reached, and a winner is usually declared when a final game threshold is reached.

Browsers such as Internet Explorer®, Firefox®, and Netscape® may be used for viewing the shared game environment, game components, and scores. Browsers usually use a protocol for communicating over the internet, referred to as Hypertext Transfer Protocol (HTTP). HTTP is a low-fidelity, slow data protocol that does not allow for multicasting, heavy data compression, and latency-sensitive multiplayer action games. Certain plug-ins provide additional functionality for browsers. Adobe Flash®, for example, features support for vector and raster graphics, a scripting language called “ActionScript,” and bidirectional streaming of audio and video. However, these plug-ins still do not provide support for high-performance latency-sensitive multiplayer gaming over the internet.

Another problem with multiplayer internet games is that parties often do not stay intact from one game to the next. Should members of a party wish to move from one game to the next, each player will separately have to log off from the old game and separately log on to the new game. Some “seats” in the new game may be reserved by other players, so that some of the members of the party belonging to the old game may not have access to the new game if seats to the new game are limited.

A further feature of existing multiplayer internet games is that a new player cannot be invited directly into a game. Instead, the new player often has to search for a game that is being played by friends or acquaintances and then has to go through a menu in order to enter the game.

### SUMMARY OF THE INVENTION

The invention provides a client computer system, including at least one storage medium, at least one processor connected to the storage medium, and a set of instructions stored on the storage medium for execution by the processor, the set of instructions including a communications module to receive and transmit signals to remote computer systems over a network, a browser residing on the storage medium, the browser having a window for displaying components in the signals, a graphical application residing on the storage medium, the graphical application utilizing the signals to render graphics, and a plug-in residing on the storage medium, the plug-in being embedding the graphics rendered by the graphical application in the window of the browser.

The client computer system may include window management events generated for or by the browser that may be communicated with the graphical application.

User input events generated and tracked by the browser may be communicated with the graphical application.

The client computer system may further include a shared game environment displayed by the client player computer system, at least one game component associated with the client computer system and each remote player computer system located in the shared game environment at the client computer system and each remote player computer system, and being movable relative to the shared game environment utilizing the respective remote player computer system, and a plurality of player scores, each player score corresponding to a respective one of the remote player computer systems, game thresholds being reached as a result of movement of the game components relative to the shared game environment, and the player scores being updated when the game thresholds are reached.

The first browser may have browser functionality and the plug-in may place a view of the shared game environment in the first browser, and the game may have game functionality.

The shared game environment, the at least one game component, the movement of the at least one game component, the player scores, and the game thresholds may be game parameters, further including a first protocol generator to communicate at least a first of the game parameters over the network, and a second protocol generator to communicate at least a second of the game parameters over the network.

The client computer system may further include a three-dimensional engine that creates a three-dimensional rendering of the shared game environment and the game components.

The invention also provides a computer communications method, including receiving a signal from a first remote computer system at a second remote computer system over a network, the signal including components for display by the remote computer system receiving the signal, running a browser application residing on the second remote computer system, the browser having a view that displays components received in the signal, rendering graphics with a graphical application residing on at least one of the remote computer systems, the graphical application utilizing the signals and a graphics acceleration to render graphics, and utilizing a plug-in on the second remote computer system to enhance functionality of the browser by embedding the graphics rendered by the graphical application in the window of the browser.

The computer communications method may further include generating window management events for or by the browser, and communicating the window management events with the graphical application.

The computer communications method may further include tracking user input events with the browser, and communicating the user input events with the graphical application.

The computer communications method may further include utilizing a plurality of remote player computer systems to move a plurality of game components associated with the respective player computers in a shared game environment displayed by the respective remote player computer systems, storing a plurality of player scores corresponding to the respective remote player computer systems, and updating the player scores as game thresholds are reached as a result of movement of the game components relative to the shared game environment.

The computer communications method may further include storing the shared game environment on a game server computer system, transmitting the shared game environment to the remote player computer systems, storing the player scores on the game server computer system, and transmitting the player scores to the remote player computer systems.

The shared game environment may be a selected shared game environment among a plurality of shared game environments, further including generating a game-specific URL, transmitting the game-specific URL to a selected one of the remote computer systems, and utilizing the game-specific URL at the selected remote computer system to at least view the selected game environment.

The computer communications method may further include storing a plurality of shared game environments on the game server computer system, and associating a respective party comprising a respective subset of the remote player computer systems with each shared game environment.

The computer communications method may further include selecting a party move selector at one of the remote player computer systems associated with a first one of the parties and a first one of the shared game environments, to transmit a party move signal from the respective remote player computer system to the server computer system, and in response to the party move signal, associating all the remote player computer systems associated with the first party in unison with a second one of the shared game environments.

The browser may have browser functionality and the plug-in may place a view of the shared game environment in the browser, and the game may have game functionality.

The computer communications method may further include running a second browser application residing on a second one of the remote computer systems, the second browser having a view that displays components received in the signal, and utilizing a second plug-in on the second remote computer system to enhance functionality of the browser, wherein the first plug-in may enhance functionality of the first browser by communicating with the second plug-in on the second remote computer system over the network.

The shared game environment, the at least one game component, the movement of the at least one game component, the player scores, and the game thresholds may be game parameters, and may further include utilizing a first protocol to communicate at least a first of the game parameters over the network, and utilizing a second protocol to communicate at least a second of the game parameters over the network.

The computer communications method may further include creating a three-dimensional rendering of the shared game environment and the game components.

The invention may further include a computer-readable medium having stored thereon a set of instructions which, when executed by a processor of a computer, may execute a communications method, including receiving a signal from a first remote computer system at a second remote computer system over a network, the signal including components for display by the remote computer receiving the signal, running a browser application residing on the second remote computer system, the browser having a view that displays components received in the signal, rendering graphics with a graphical application residing on at least one of the remote computer systems, the graphical application utilizing the signals and a graphics acceleration to render graphics, and utilizing a plug-in on the second remote computer system to enhance functionality of the browser by embedding the graphics rendered by the graphical application in the window of the browser.

The invention further provides a network system, including a plurality of remote computer systems connected to a network, a signal being transmitted from a first to a second of the remote computer systems over the network, the signal including components for display by the remote computer receiving the signal, a browser residing on the second remote computer system, the browser having a window for displaying components in the signal, a graphical application residing on the second remote computer system, and a plug-in residing on the second remote computer system, the plug-in being utilized to enhance functionality of the browser by embedding the graphics rendered by the graphical application in the window of the browser.

### BRIEF DESCRIPTION OF THE DRAWINGS

The invention is further described by way of example with reference to the accompanying drawings, wherein:

FIG. 1 is a block diagram of a network system as it relates to one embodiment of the invention;

FIG. 2 is a block diagram of components residing on a game server computer system of the network system of FIG. 1;

FIG. 3 is a screenshot showing a browser and a view of a multiplayer game;

FIG. 4 is a block diagram showing the game server computer system and various components residing on one of a plurality of the remote player computer systems in FIG. 1;

FIG. 5 is a block diagram illustrating how a game is created, initiated, joined, and a how a party is moved from one game to the next;

FIG. 6 is a screenshot showing a view of a game lobby in FIG. 5;

FIG. 7 is a screenshot of a multiplayer game view that is displayed upon selection of a game;

FIG. 8 is a flowchart illustrating how a new user can be invited into and can join a live game session; and

FIG. 9 is a block diagram of a machine in the form of a computer that can find application in the present invention system, in accordance with one embodiment of the invention.

### DETAILED DESCRIPTION OF THE INVENTION

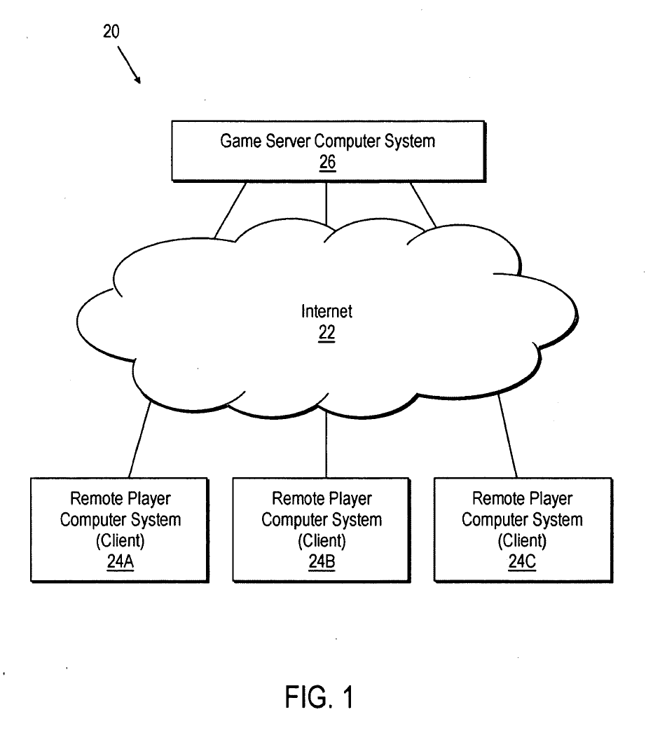

FIG. 1 of the accompanying drawings illustrates a network system 20 as it relates to one embodiment of the invention, including at least one network in the form of the internet 22, a plurality of remote player computer systems 24A, 24B, and 24C, and a game server computer system 26 connected to the internet 22. A signal can be transmitted from a first of the remote player computer systems 24A to a second of the remote player computer systems 24B over the internet 22. The signal includes components displayed by the remote player computer system 24B receiving the signal. More specifically, in the embodiment of FIG. 1 having a game server computer system 26, the signal is first transmitted from the first remote player computer system 24A over the internet 22 to the game server computer system 26, the signal is then possibly converted by the game server computer system 26, and is then transmitted from the game server computer system 26 over the internet 22 to the second remote player computer system 24B, and is then received by the second remote computer system 24B. The remote player computer system 24A, 25B, or 24C is also sometimes referred to as “the client computer system” herein. For purposes of expediency, transmission and reception is not described in every instance herein, but it should be understood that a communication will include at least one transaction that includes transmission and reception of a signal.

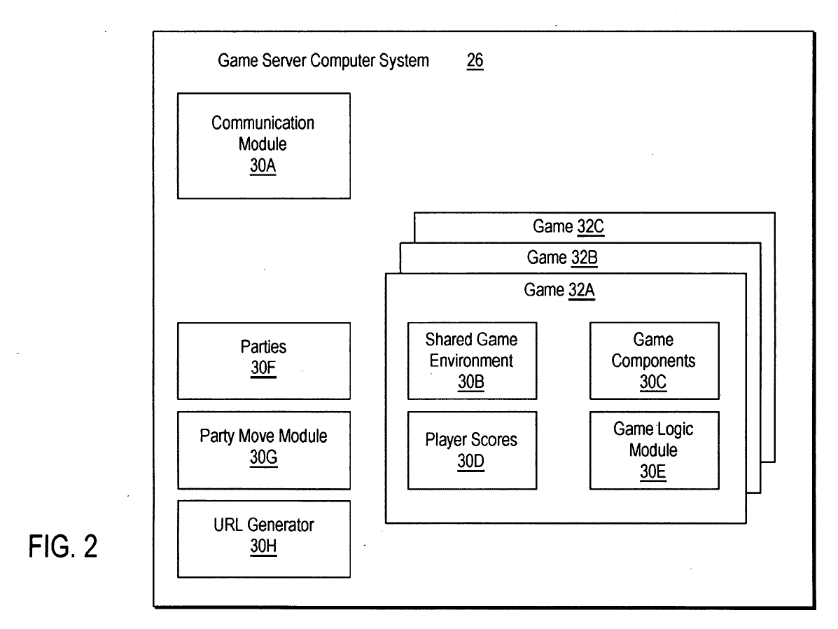

As shown in FIG. 2, the game server computer system 26 includes a plurality of components or modules stored thereon, including a communication module 30A, a shared game environment 30B, a plurality of game components 30C, each associated with a respective one of the remote player computer systems 24A, 24B, and 24C in FIG. 1, a plurality of player scores 30D, each associated with a respective one of the remote player computer systems 24A, 24B, and 24C in FIG. 1, a game logic module 30E, a plurality of parties 30F, a party move module 30G, and a Uniform Resource Locator (URL) generator 30H.

The shared game environment 30B, the game components 30C, and the player scores 30D are all stored on the game server computer system 26 and are transmitted to the remote player computer systems 24A, 24B, and 24C in FIG. 1 via the communication module 30A. The communication module 30A is also responsible for receiving signals from the remote player computer systems 24A, 24B, and 24C in FIG. 1 for processing at the game server computer system 26. The game logic module 30E controls functionality of the game, including setting and controlling thresholds that have to be reached for the player scores 30D to be updated.

The shared game environment 30B, plurality of game components 30C, plurality of player scores 30D, and game logic module 30E are all associated with a single game 32A. A plurality of different games 32A, 32B, and 32C are stored on the game server computer system 26. Each game 32A, 32B, and 32C includes respective components similar to the shared game environment 30B, plurality of game components 30C, plurality of player scores 30D, and game logic module 30E, but for different ones of the same type of game or for different types of games.

The parties 30F each include a respective subset of the remote player computer systems 24A, 24B, and 24C in FIG. 1. Each one of the parties 30F is associated with a respective one of the shared game environments 30B.

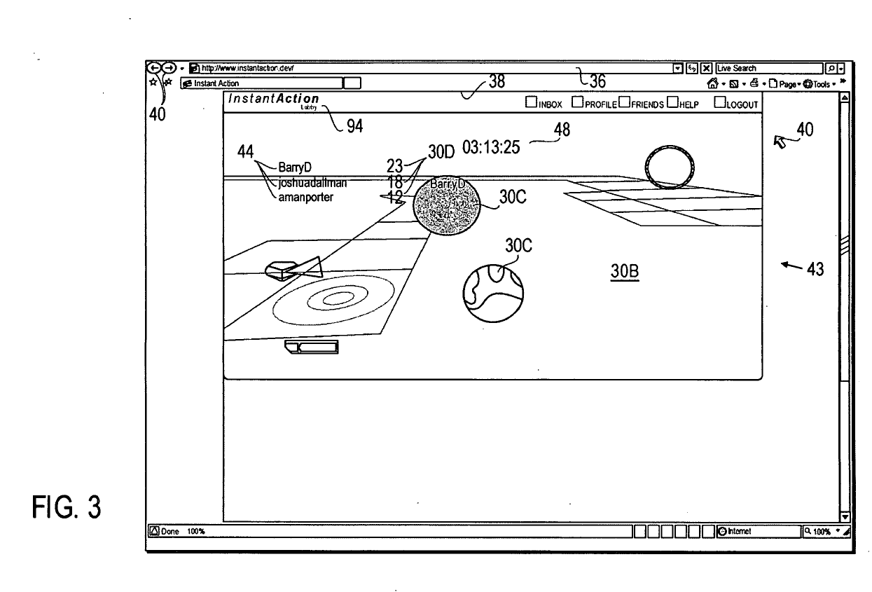

FIG. 3 illustrates a browser interface 34. The browser interface 34 may, for example, be an interface of Internet Explorer®, Firefox®, Netscape®, or any other browser. The browser interface 34 has an address box 36, a viewing pane 38, and various buttons such as back and forward buttons 40. The browser is loaded on each one of the remote player computer systems 24A, 24B, and 24C in FIG. 1. A respective user at a respective one of the client computer systems 24A, 24B, or 24C can load the browser interface 34 into memory. The browser interface 34 can be displayed on a screen or a display of the client computer system 24A, 24B, or 24C.

The user enters an address in the address box 36. The user uses a mouse to move a cursor 42 into the address box 36, and then clicks a button on the mouse. After clicking the button on the mouse, the user can use a keyboard to enter text into the address box 36. The user can press “Enter” on the keyboard. A command is sent over the internet 22 in FIG. 1 requesting a page corresponding to the address that is entered into the address box 36. The page is retrieved and transmitted to the client computer system 24A, 24B, or 24C and is displayed within the viewing pane 38. An address can also be automatically entered in the address box 36 and be transmitted due to an earlier or subsequent action by the user on the respective client computer system 24A, 24B, or 24C.

FIG. 3 also illustrates a view 43 of components of the game 32A in FIG. 2 that are transmitted from the game server computer system 26, including the shared game environment 30B, the game components 30C, and the player scores 30D. The view 43 also includes nicknames 44 of players corresponding to each one of the remote player computer systems 24A, 24B, and 24C in FIG. 1. The nicknames 44 in the view 43 together form one of many parties among the parties 30F in FIG. 1, and the respective party is associated with a respective game 32A in FIG. 1.

Each one of the game components 30C is also associated with each one of the remote player computer systems 24A, 24B, and 24C in FIG. 1. A selected one of the nicknames 44, player scores 30D, and game components 30C are also associated with the respective client computer system 24, e.g., the client computer system 24A, displaying the browser interface 34. The respective user at the client computer system 24A can move the selected game component 30C by providing user input events utilizing a mouse, keyboard, joystick, or other user interface device of the client computer system 24A. The shared game environment 30B has a range of perspectives that continues to change as the user moves the game component 30C through the shared game environment 30B.

A view such as the view 43 is displayed on displays of all the remote player computer systems 24A, 24B, and 24C forming part of the respective party 30F. A different one of the game components 30C is associated with a respective one of the remote player computer systems 24A, 24B, and 24C, and can only be moved and controlled at the respective remote player computer system 24A, 24B, or 24C to which it belongs. The view that is displayed at each remote player computer system 24A, 24B, and 24C will include a different perspective of the same shared game environment 30B.

The game logic module 30E in FIG. 1 detects and calculates when predefined game thresholds are reached, and updates the player scores 30D when the game thresholds are reached. The game thresholds may, for example, be reached when one of the game components 30C bumps another one of the game components 30C onto a lower level. The game logic module 30E then updates one or more of the player scores 30D by, for example, increasing of the scores corresponding to the game component 30C that bumped the other game component 30C onto a lower level. In the present game, the game is over after a clock 48 (forming part of the game logic module 30E in FIG. 2) has counted down to zero. The nickname 44 with the highest player score 30D is then declared the winner (by the game logic module 30E in FIG. 2).

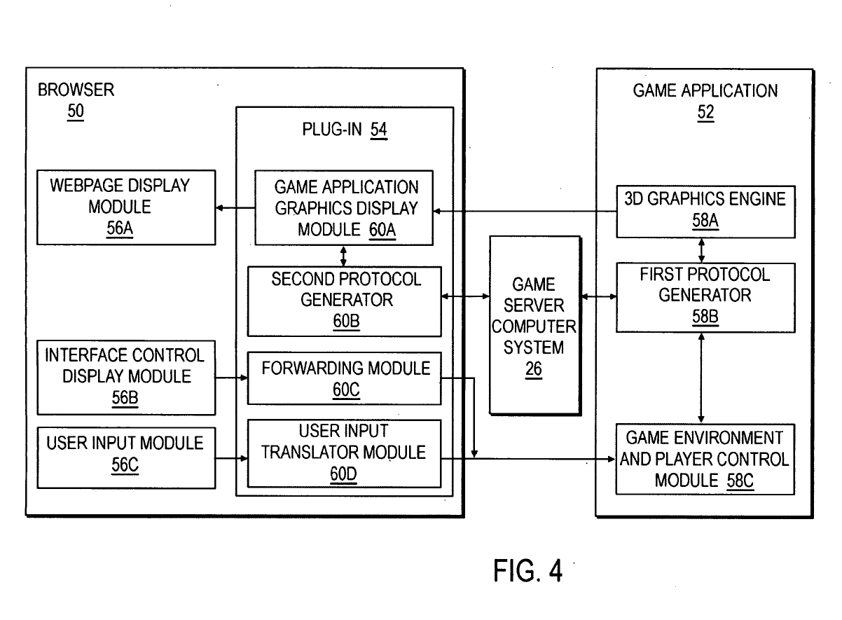

FIG. 4 illustrates the game server computer system 26 and components that are installed on each one of the remote player computer systems 24A, 24B, and 24C in FIG. 1, including an executable application in the form of a browser 50, an executable game application 52, and a plug-in 54 for the browser 50.

The browser 50 has browser functionality and includes a webpage display module 56A, an interface control display module 56B, and a user input module 56C.

The webpage display module 56A includes the browser interface 34 that is displayed in FIG. 3 and is also responsible for displaying the view 43 and the cursor 42 in FIG. 3.

The interface control display module 56B displays interface control components. Interface control components may, for example, be buttons, sliders, fields, etc. Interface control components may be used to customize and adjust settings of games.

The user input module 56C receives user input events from user interface devices. User input events may, for example, be a key press on a keyboard, a click on a button of a mouse, movement of a mouse in a selected direction, the click of a button on a game-specific user input device such as a joystick, or movement of a movable component relative to a base of a game-specific device, for example, movement of a handle of a joystick or rotation of a steering wheel.

The game application 52 has game functionality and includes a three-dimensional graphics engine 58A, a first protocol generator 58B, and a game environment and player control module 58C.

The three-dimensional graphics engine 58A is a high-speed graphics engine that typically communicates with a graphics accelerator on a graphics card for purposes of rendering three-dimensional views at high speed, as is required by advanced three-dimensional games. This three-dimensional graphics engine 58A is responsible for generating three-dimensional views of the shared game environment 30B, game components 30C, and shadows in FIG. 3.

The game environment and player control module 58C includes some game logic in addition to the game logic residing in the game logic module 30E in FIG. 2. The shared game environment and player control module 58C controls certain aspects of the game environment and players that form part of a single game.

The three-dimensional graphics engine 58A and the game environment and player control module 58C are both in communication with the first protocol generator 58B. The first protocol generator 58B communicates with the game server computer system 26. The first protocol generator 58B creates multi-client data connections. The first protocol generator 58B may use a protocol such as Universal Datagram Protocol (UDP). UDP, when compared to HTTP, is a high-fidelity, fast data protocol that multicasts, allows for heavy data compression, and allows for latency-sensitive multiplayer action games in the browser 50. These features of the first protocol generator 58B allow for fast communication between the three-dimensional graphics engine 58A and the game server computer system 26. In another embodiment, the first protocol generator 58B may connect directly to other remote player computer systems in a peer-to-peer arrangement, rather than the server-based arrangement of FIG. 1.

The plug-in 54 has a number of modules that, alone and in combination, enhance functionality of the browser 50, including a game application graphics display module 60A, a second protocol generator 60B, a forwarding module 60C, and a user input translator module 60D.

The game application graphics display module 60A connects the three-dimensional graphics engine 58A to the web page display module 56A. The game application graphics display module 60A displays the view 43 in the viewing pane 38 of the browser interface 34 in FIG. 3.

The forwarding module 60C is connected to the interface control display module 56B. The forwarding module 60C forwards customization and settings from the interface control display module 56B to the game environment and player control module 58C of the game application 52. The user input translator module 60D receives and translates the user input events from the user input module 56C and forwards the translated user input event to the game environment and player control module 58C.

The second protocol generator 60B is used to generate a low-fidelity, slow data protocol, compared to UDP, such as HTTP, that does not multicast, does not use heavy data compression, or enable latency-sensitive multiplayer action games in a browser. The second protocol generator 60B is used for communicating (transmit and/or receive) data other than what is generated by the game application 52 with the game server computer system 26. The second protocol generator 60B may, for example, communicate a window management event, the clock 48, player scores 30D, and nicknames 44 in FIG. 3 to and from the game server computer system 26. The data that is communicated through the second protocol generator 60B does not pass through the first protocol generator 58B, so that the first protocol generator 58B can be reserved for communicating only data that is performance-sensitive. Data that is not performance-sensitive is not communicated through the first protocol generator 58B so as not to reduce the performance of the first protocol generator 58B. Performance-sensitive data is not communicated through the second protocol generator 60B because of the inability of the second protocol generator 60B to effectively communicate high-performance data.

It can be seen how the plug-in 54 enhances functionality of the browser 50 by displaying graphics rendered by the three-dimensional graphics engine 58A of the game application to be viewed utilizing the web page display module 56A of the browser 50, by utilizing the user input translator module 60D to translate user input events detected by the user input module 56C to the game environment and player control module 58C of the game application 52, by utilizing the forwarding module 60C to forward customization and settings to the game application 52, and by providing the second protocol generator 60B to communicate with the game server computer system 26.

What should also be noted is the interaction of webpage components/controls with game components. For example, users can click a button on the webpage, and seemlessly see changes in their game. As an example, a web interface is provided that allows users to pick an individual marble type from amongst many choices. The marble selector interface is done entirely on the with HTML,HTMLS CSS, or even Flash UI components. When the user selects a marble, the webpage triggers a javascript event that evokes a plug-in and passes along the appropriate marble parameters, and the plug-in informs the game application to select the appropriate marble, and the game then renders the correct marble in-game. Similar systems for selecting tanks with different looks and gameplay attributes are provided through web interfaces. The same functionality for choosing levels for games through web interfaces, etc can also be provided.

For Windows®, for example, the plug-in 54 is an ActiveX control configured to execute the external graphical application and pass it a window handle to use when initializing its graphics context. To do this in Windows®, the window handle “m_hWnd,” which is a data member inherited through CWindowImpl, of the plug-in 54 is used as follows:

String args=ToString(“-window % d”,m_hWnd);

execute(exePath,workDir,args);

The result is then passed to the game application 52 on the command line when we start it using the standard Windows CreateProcess( ) function:

```
      bool execute(Path exePath,Path workPath,String args)
{
  // Define standard environment variables
  String env = ToString(“SYSTEMROOT=%s%cSYSTEMDRIVE=
  %s%c\0”,
    getenv(“SYSTEMROOT”),‘\0’,getenv(“SYSTEMDRIVE”),‘\0’);
  // Command line is full game path + args
  String command = exePath + “ ” + args;
  wchar_t wcommand[1024];
  mbstowcs(wcommand,command.c_str( ),sizeof(wcommand));
  // Set the current working directory to the location of the exe
  wchar_t wcwd[1024];
  mbstowcs(wcwd,String(workPath).c_str( ),sizeof(wcwd));
  STARTUPINFO si;
  ZeroMemory(&si,sizeof(si));
  si.cb = sizeof(si);
  return (CreateProcess(
    0, // Application
    wcommand, // Command line
    0, // Process attributes
    0, // Security attributes
    false, // Inherit handles
    NORMAL_PRIORITY_CLASS,
    (void*)env.c_str( ), // Environment vars.
    wcwd, // CWD
    &si,
    &_pi));
}
```

The data structure called “STARTUPINFO” above is for calling the game application 52.

For the game application 52, what is required is to accept the command line argument as a Windows HWND, use it to get the required size, and then to initialize the required graphics context with it. Communication with the plug-in 54 is then embedded into the game application 52.

```
HWND parent = NULL;
sscanf(lpCmdLine,“-window %d ”,&parent);
if ( !parent || !IsWindow(parent) )
  return 1;
memset(&uMsg,0,sizeof(uMsg));
winClass.lpszClassName = “MY_WINDOWS_CLASS”;
winClass.cbSize = sizeof(WNDCLASSEX);
winClass.style = CS_HREDRAW | CS_VREDRAW;
winClass.lpfnWndProc = WindowProc;
winClass.hInstance = hInstance;
winClass.hIcon = LoadIcon(hInstance,
(LPCTSTR)IDI_DIRECTX_ICON);
winClass.hIconSm = LoadIcon(hInstance,
(LPCTSTR)IDI_DIRECTX_ICON);
winClass.hCursor = LoadCursor(NULL, IDC_ARROW);
winClass.hbrBackground =
(HBRUSH)GetStockObject(BLACK_BRUSH);
winClass.lpszMenuName = NULL;
winClass.cbClsExtra = 0;
winClass.cbWndExtra = 0;
if( !RegisterClassEx(&winClass) )
  return 1;
// Get our window size
RECT rect;
GetClientRect(parent,&rect);
// create the window
g_hWnd = CreateWindowEx( NULL, “MY_WINDOWS_CLASS”,
        “Direct3D (DX9) - Example”,
        WS_VISIBLE | WS_CLIPSIBLINGS
      | WS_CLIPCHILDREN | WS_CHILDWINDOW,
        0, 0, rect.right - rect.left, rect.bottom - rect.top,
        parent, NULL, hInstance, NULL );
```

Communication between the game application 52 and the plug-in 54 may be accomplished using sockets, named pipes, or shared memory. When the plug-in 54 launches the game application 52, it passes information on the command line to tell the game application 52 where and how to connect back to the plug-in 54. The plug-in 54 may, for example, set the port according to the following procedure:

String args = ToString(“-port %d”,m_port);
execute(exePath,workDir,args);

The result is passed on to the game application 52 on the command line when the standard Windows CreateProcess( ) function is initiated:

```
bool execute(Path exePath,Path workPath,String args)
{
  // Define standard environment variables
  String env = ToString(“SYSTEMROOT=%s%cSYSTEMDRIVE=
  s%c\0”,
getenv(“SYSTEMROOT”),‘\0’,getenv(“SYSTEMDRIVE”),‘\0’);
  // Command line is full game path + args
  String command = exePath + “ ” + args;
  wchar_t wcommand[1024];
  mbstowcs(wcommand,command.c_str( ),sizeof(wcommand));
  // Set the current working directory to the location of the exe
  wchar_t wcwd[1024];
  mbstowcs(wcwd,String(workPath).c_str( ),sizeof(wcwd));
  STARTUPINFO si;
  ZeroMemory(&si,sizeof(si));
  si.cb = sizeof(si);
  return (CreateProcess(
    0, // Application
    wcommand, // Command line
    0, // Process attributes
    0, // Security attributes
    false, // Inherit handles
    NORMAL_PRIORITY_CLASS,
    (void*)env.c_str( ), // Environment vars.
    wcwd, // CWD
    &si,
    &_pi));
}
```

For the game application 52, what is then required is to accept the command line argument and use it when opening the connection to the plug-in 54.

unsigned int port = 0;
sscanf(lpCmdLine,“-port %d ”,&port);
ConnectToPlugin( port );

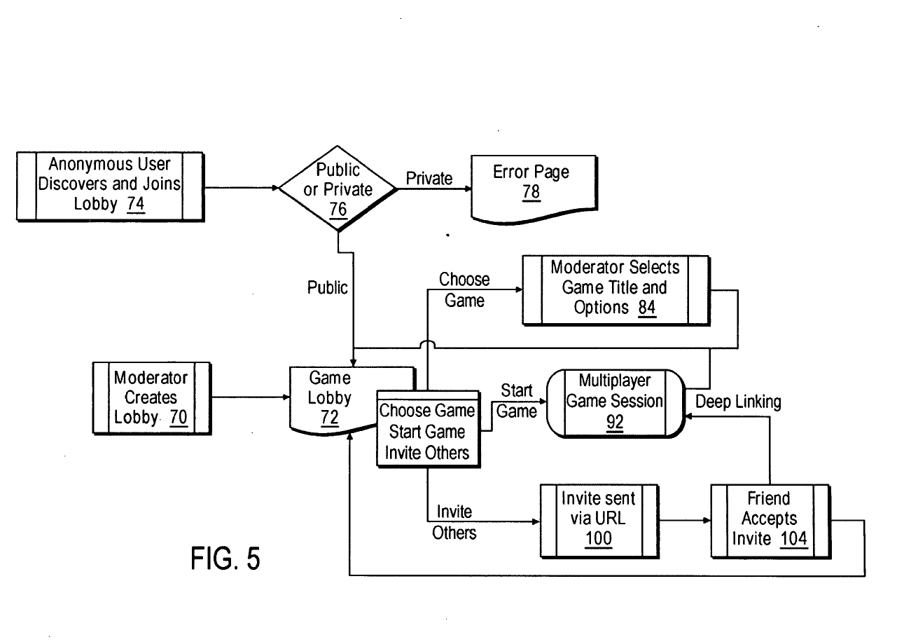

FIG. 5 is a block diagram that illustrates how a host or moderator selects a game, invites players, and moves a party. FIG. 5 also illustrates how an anonymous user can join a game.

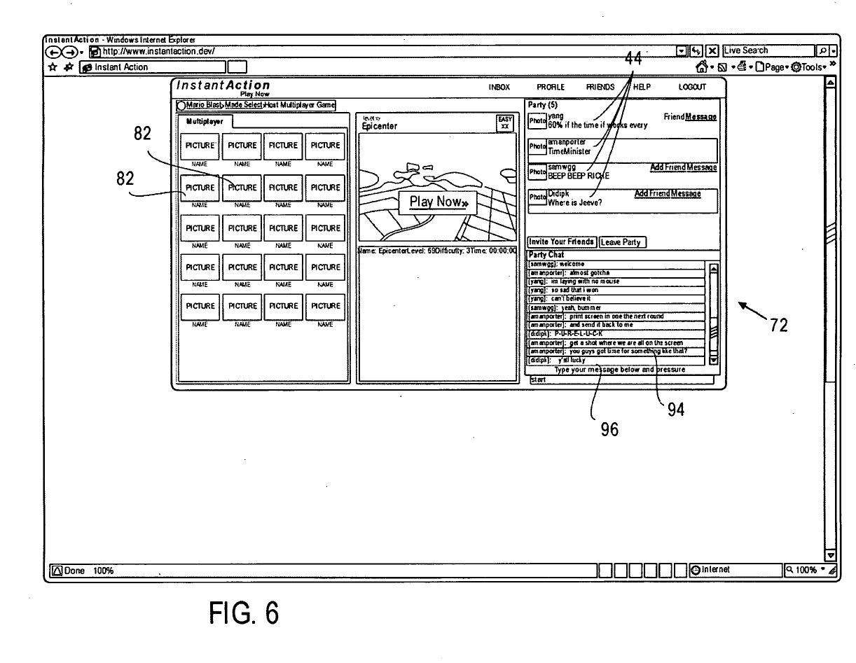

At block 70, the moderator creates a game lobby 72 shown in FIG. 6. The game lobby 72 is stored on the game server computer system 26 in FIG. 1, and is downloadable and viewable at each one of the remote player computer systems 24A, 24B, and 24C. FIG. 6 illustrates the game lobby 72 after the moderator has downloaded the game lobby 72 from the game server computer system 26 onto, for example, the remote player computer system 24A in FIG. 1.

Referring again to FIG. 5, at block 74, an anonymous user can discover and attempt to join the game lobby 72 through a different interface (not shown). The game lobby 72 may be marked either “public” or “private” by the moderator when creating the game lobby 72 at block 70. In the event that the game lobby 72 is marked “private,” the anonymous user from block 74 will, at block 76, be directed to an error page 78. The anonymous user will thus not be allowed to enter the game lobby 72. Should the game lobby 72 be marked “public,” the anonymous user from block 74 will at block 76 be directed into the game lobby 72. In this manner, the anonymous user will become a player and a member of a party associated with the game lobby 72. FIG. 6 shows the nicknames 44 of the member players belonging to the party associated with the particular lobby 72.

As represented by block 80 in FIG. 5, the game lobby 72 gives the moderator a number of options, including choosing a game, starting a game, and inviting others. The moderator from block 70 chooses the game first and then starts the game, but it is possible for the moderator to invite others at any stage, i.e., before choosing a game, after choosing the game but before starting the game, or after a game is already in progress.

As shown in FIG. 6, the lobby 72 includes a plurality of game icons 82 that represent different games. At block 84 in FIG. 5, the moderator selects one of the games by clicking on one of the game icons 82.

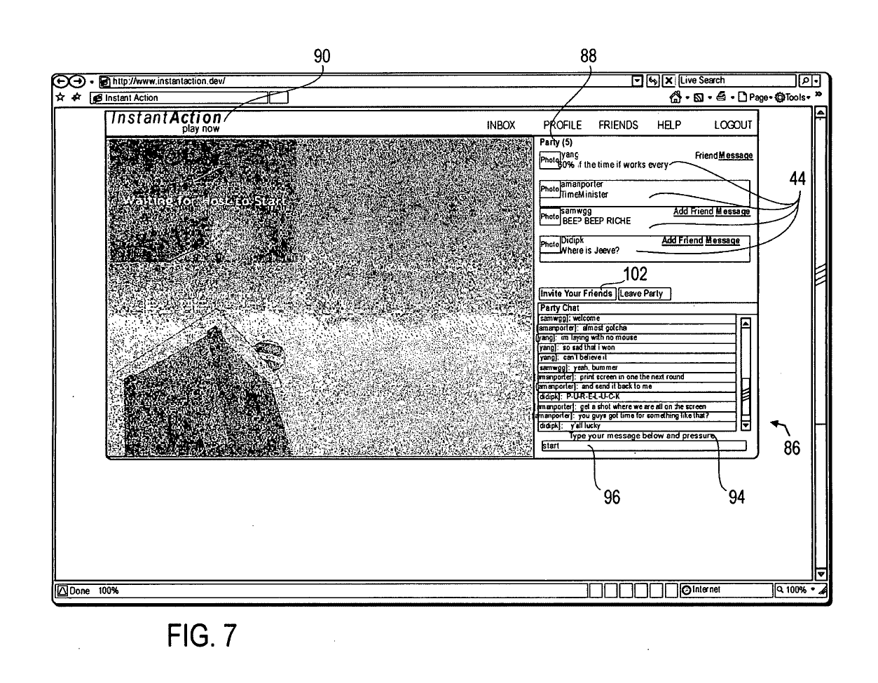

Before selecting one of the game icons 82, the game lobby 72 is displayed at the remote player computer systems 24A in FIG. 1 of all the members of the party represented by the nicknames 44 in FIG. 6. FIG. 7 shows a multiplayer game view 86 that replaces the game lobby 72 of FIG. 6 upon selection of one of the game icons 82 in FIG. 6. The same multiplayer game view 86 is displayed at each one of the remote player computer systems 24A in FIG. 1 corresponding to the nicknames 44 in the lobby 72 of FIG. 5 and the multiplayer game view 86 of FIG. 7. The multiplayer game view 86 also includes a lobby selector 88 that the moderator can select to return to the game lobby 72 of FIG. 6.

The multiplayer game view 86 of FIG. 7 is thus an extension of the game lobby 72 of FIG. 6.

As mentioned, the moderator can start the game at block 80 in FIG. 5. The multiplayer game view 86 of FIG. 7 includes a “play now” selector 90 that is only displayed to the moderator and not to the other players. Upon selection of the “play now” selector 90, the view 43 of FIG. 3 is displayed at each one of the remote player computer systems 24A, 24B, and 24C in FIG. 1 corresponding to the nicknames 44 in FIGS. 6 and 7. Referring to FIGS. 3 and 5 in combination, the moderator has thus started a multiplayer game session, as represented by block 92.

The view 43 includes a “lobby” selector 94. If the moderator selects the “lobby” selector 94, the moderator will be returned to the game lobby 72 shown in FIG. 5 and FIG. 6, from where the moderator can choose another game at block 80 in FIG. 5 and by selecting another one of the game icons 82 in FIG. 6. Upon selection of the game, the moderator selects a game title and options at block 84, whereafter the moderator returns to the game lobby 72 and starts the new game at block 80. Another game view that is different from the view 43 of FIG. 3 is then displayed at each one of the remote player computer systems 24A in FIG. 1 corresponding to the nicknames 44 in FIGS. 6 and 7 of the particular party. The actions of the moderator have thus caused movement of the entire party from one game to another game (see reference numerals 32A, 32B, and 32C in FIG. 2) without adding or subtracting any members of the party.

In another embodiment, members of the party can vote for new games and the entire party will be moved from an old game to a new name, the new game depending on the outcome of the vote.

When moving the entire party in unison, there is no need for individual players to separately rejoin a new game. The entire party can thus be moved in a fast and efficient manner. This feature is also useful in games where a limited number of “seats” are available that can be taken up by players not belonging to the party of the old game, and thus block certain members of the party of the old game out of the new game. Friends and acquaintances can also remain in the same party from one game to the next. As mentioned, the parties are stored on the game server computer system 26 in FIG. 1. Movement of parties from one game to the next is also controlled by the game server computer system 26, in particular, the party move module 30G of FIG. 2.

The game lobby 72 in FIG. 6 and the multiplayer game view 86 of FIG. 7 both include a party chat area 95. The members of the party can send messages by typing in a text area 96, and so communicate back and forth with one another. The members of the party may also communicate with one another utilizing voice over internet protocol (VoIP) to create a conference only between members of the party.

In the game lobby 72 of FIG. 6, the game icons 82 serve the dual purpose of being a game selector and a party move selector. In another embodiment, a party move selector may be separate from a game selector and may be located in the game lobby 72 view, the multiplayer game view 86 of FIG. 7, or the view 43 of FIG. 3.

Referring again to FIG. 5, the moderator at block 80 can also invite friends or acquaintances by sending a URL at block 100. As shown in FIGS. 6 and 7, links 102 are selectable by the moderator for purposes of such invitations. As further shown in FIG. 5, a friend or acquaintance can accept an invitation at block 104. The invitation is typically in the form of an e-mail that is transmitted from the game server computer system 26 in FIG. 1 to one of the remote player computer systems 24, e.g., the player computer system 24B. The e-mail includes the URL that is sent at block 100. The friend accepts the invitation by selecting the URL at block 104. Upon selection of the URL, the remote player computer system 24B in FIG. 1 opens a browser and downloads the game lobby 72 in FIG. 5 and FIG. 6.

An invited user can alternatively enter the multiplayer game session 92 directly instead of going through the game lobby 72, a feature of the invention referred to as “deep linking” and represented by the line connecting block 104 directly to block 92 in FIG. 5.

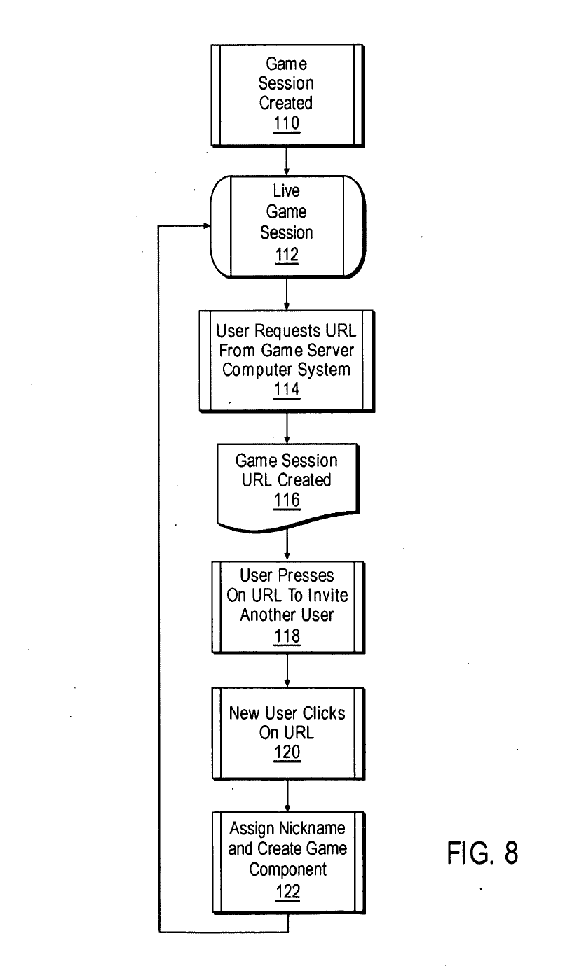

FIG. 8 is a flowchart that illustrates how deep linking is accomplished. At block 110, a game session is created and at block 112, a live game session is initiated as hereinbefore described. Upon initiation of the live game session, a game view such as the view 43 in FIG. 3 is displayed. At block 114, a user, typically the moderator, requests a URL from the game server computer system 26 in FIG. 1. The URL generator 30H in FIG. 2 generates a URL at block 116 in FIG. 8, based on the unique game, live game session, and players in the game, encoding this information into the URL for later decoding. The URL is then transmitted back to the user requesting the URL. A URL is also automatically created when a game session is started and is transmitted to each player. At block 118, the user requesting the URL passes the URL onto an invited user. The URL may, for example, be e-mailed to the invited user. At block 120, the new, invited user clicks on the URL so that a browser is opened. The browser also utilizes the URL to direct the browser to the game server computer system 26 in FIG. 1. The game server computer system 26 compares the URL with the URL that was transmitted following the request at block 114 and, only upon a favorable comparison, proceeds to block 122. At block 122, the game server computer system 26 assigns a nickname 44 and creates a game component for the new invited user. The game server computer system 26 then decodes the URL according to the game session URL encoding algorithm, identifies the proper game session to join and directs the browser of the new invited user to the live game session at block 112. The browser of the new invited user then displays a view that includes the shared game environment 30B of FIG. 3 and a new game component 30C for the new invited user. The nicknames 44 and the player scores 30D are updated to include the nickname and score of the new invited user.

The new invited user has thus automatically joined the game by simply selecting the URL. There is thus no need for the new invited user to search for any games that friends or acquaintances are playing or for the new user to click through a menu in order to access a selected game.

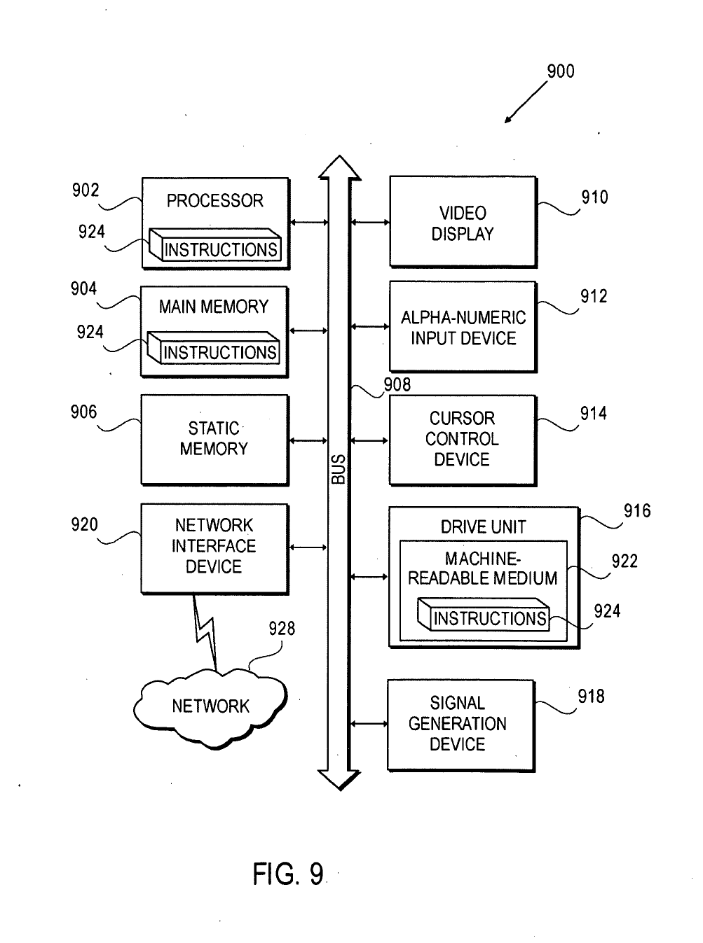

FIG. 9 shows a diagrammatic representation of a machine in the exemplary form of a computer network system 900 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 902 (e.g., a central processing unit (CPU), a graphics processing unit (GPU) or both), a main memory 904 (e.g., read-only memory (ROM), flash memory, dynamic random access memory (DRAM) such as synchronous DRAM (SDRAM) or Rambus DRAM (RDRAM), etc.), and a static memory 906 (e.g., flash memory, static random access memory (SRAM), etc.), which communicate with each other via a bus 908.

The computer system 900 may further include a video display 910 (e.g., a liquid crystal display (LCD) or a cathode ray tube (CRT)). The computer system 900 also includes an alpha-numeric input device 912 (e.g., a keyboard), a cursor control device 914 (e.g., a mouse), a disk drive unit 916, a signal generation device 918 (e.g., a speaker), and a network interface device 920. Other game-specific user input devices such as a joystick or a steering wheel may also be connected to the bus 908.

The disk drive unit 916 includes a machine-readable medium 922 on which is stored one or more sets of instructions 924 (e.g., software) embodying any one or more of the methodologies or functions described herein. The software may also reside, completely or at least partially, within the main memory 904 and/or within the processor 902 during execution or running thereof by the computer system 900, the main memory 904 and the processor 902 also constituting machine-readable media.

The software may further be transmitted or received over a network 928 via the network interface device 920.

While the machine-readable medium 924 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A client computer system, comprising:
at least one storage medium;
at least one processor connected to the storage medium; and
a set of instructions stored on the storage medium for execution by the processor, the set of instructions including:
a communications module to receive and transmit signals to remote computer systems over a network;
a browser residing on the storage medium, the browser having a window for displaying components in the signals;
a graphical application residing on the storage medium, the graphical application utilizing the signals to render graphics; and
a plug-in residing on the storage medium, the plug-in being embedding the graphics rendered by the graphical application in the window of the browser.

2. The client computer system of claim 1, wherein window management events generated for or by the browser are communicated with the graphical application.

3. The client computer system of claim 1, wherein user input events generated and tracked by the browser are communicated with the graphical application.

4. The client computer system of claim 1, further comprising:
a shared game environment displayed by the client player computer system;
at least one game component associated with the client computer system and each remote player computer system located in the shared game environment at the client computer system and each remote player computer system, and being movable relative to the shared game environment utilizing the respective remote player computer system; and
a plurality of player scores, each player score corresponding to a respective one of the remote player computer systems, game thresholds being reached as a result of movement of the game components relative to the shared game environment, and the player scores being updated when the game thresholds are reached.

5. The client computer system of claim 1, wherein the first browser has browser functionality and the plug-in places a view of the shared game environment in the first browser, and the game has game functionality.

6. The client computer system of claim 1, wherein the shared game environment, the at least one game component, the movement of the at least one game component, the player scores, and the game thresholds are game parameters, further comprising:
a first protocol generator to communicate at least a first of the game parameters over the network; and
a second protocol generator to communicate at least a second of the game parameters over the network.

7. The client computer system of claim 4, further comprising:
a three-dimensional engine that creates a three-dimensional rendering of the shared game environment and the game components.

8. A computer communications method, comprising:
receiving a signal from a first remote computer system at a second remote computer system over a network, the signal including components for display by the remote computer system receiving the signal;
running a browser application residing on the second remote computer system, the browser having a view that displays components received in the signal;
rendering graphics with a graphical application residing on at least one of the remote computer systems, the graphical application utilizing the signals and graphics acceleration to render graphics; and
utilizing a plug-in on the second remote computer system to enhance functionality of the browser by embedding the graphics rendered by the graphical application in the window of the browser.

9. The computer communications method of claim 8, further comprising:
generating window management events for or by the browser; and
communicating the window management events with the graphical application.

10. The computer communications method of claim 8, further comprising:
tracking user input events with the browser; and
communicating the user input events with the graphical application.

11. The computer communications method of claim 8, further comprising:
utilizing a plurality of remote player computer systems to move a plurality of game components associated with the respective player computers in a shared game environment displayed by the respective remote player computer systems;
storing a plurality of player scores corresponding to the respective remote player computer systems; and
updating the player scores as game thresholds are reached as a result of movement of the game components relative to the shared game environment.

12. The computer communications method of claim 11, further comprising:
storing the shared game environment on a game server computer system;
transmitting the shared game environment to the remote player computer systems;
storing the player scores on the game server computer system; and
transmitting the player scores to the remote player computer systems.

13. The computer communications method of claim 12, wherein the shared game environment is a selected shared game environment among a plurality of shared game environments, further comprising:
generating a game-specific URL;
transmitting the game-specific URL to a selected one of the remote computer systems; and
utilizing the game-specific URL at the selected remote computer system to at least view the selected game environment.

14. The computer communications method of claim 12, further comprising:
storing a plurality of shared game environments on the game server computer system; and
associating a respective party comprising a respective subset of the remote player computer systems with each shared game environment.

15. The computer communications method of claim 14, further comprising:
selecting a party move selector at one of the remote player computer systems associated with a first one of the parties and a first one of the shared game environments, to transmit a party move signal from the respective remote player computer system to the server computer system; and
in response to the party move signal, associating all the remote player computer systems associated with the first party in unison with a second one of the shared game environments.

16. The computer communications method of claim 8, wherein the browser has browser functionality and the plug-in places a view of the shared game environment in the browser, and the game has game functionality.

17. The computer communications method of claim 12, further comprising:
running a second browser application residing on a second one of the remote computer systems, the second browser having a view that displays components received in the signal; and
utilizing a second plug-in on the second remote computer system to enhance functionality of the browser,
wherein the first plug-in enhances functionality of the first browser by communicating with the second plug-in on the second remote computer system over the network.

18. The computer communications method of claim 11, wherein the shared game environment, the at least one game component, the movement of the at least one game component, the player scores, and the game thresholds are game parameters, further comprising:
utilizing a first protocol to communicate at least a first of the game parameters over the network; and
utilizing a second protocol to communicate at least a second of the game parameters over the network.

19. The computer communications method of claim 11, further comprising:
creating a three-dimensional rendering of the shared game environment and the game components.

20. A computer-readable medium having stored thereon a set of instructions which, when executed by a processor of a computer, executes a communications method, comprising:
receiving a signal from a first remote computer system at a second remote computer system over a network, the signal including components for display by the remote computer receiving the signal;
running a browser application residing on the second remote computer system, the browser having a view that displays components received in the signal;
rendering graphics with a graphical application residing on at least one of the remote computer systems, the graphical application utilizing the signals and a graphics acceleration to render graphics; and
utilizing a plug-in on the second remote computer system to enhance functionality of the browser by embedding the graphics rendered by the graphical application in the window of the browser.

21. A network system, comprising:
a plurality of remote computer systems connected to a network, a signal being transmitted from a first to a second of the remote computer systems over the network, the signal including components for display by the remote computer receiving the signal;
a browser residing on the second remote computer system, the browser having a window for displaying components in the signal;
a graphical application residing on the second remote computer system; and
a plug-in residing on the second remote computer system, the plug-in being utilized to enhance functionality of the browser by embedding the graphics rendered by the graphical application in the window of the browser.
